(19) United States
(12) Patent Application Publication
(10) Pub. No.: US 2016/0041589 A1
(43) Pub. Date: Feb. 11, 2016

(54) PROGRESSIVE HINGE

(71) Applicant: Microsoft Corporation, Redmond, WA (US)

(72) Inventor: Errol M. TAZBAZ, Bellevue, WA (US)

(73) Assignee: Microsoft Corporation, Redmond, WA (US)

(21) Appl. No.: 14/452,330

(22) Filed: Aug. 5, 2014

(51) Int. Cl. G06F 1/16

(52) U.S. Cl. CPC G06F 1/1681; G06F 1/1637

(57) ABSTRACT

The description relates to devices, such as computing devices that have hinged portions. One example can include a first portion that includes an electronic component and is electrically connected by electrical conductors to a second portion that includes a second electronic component. This example can also include a two axis hinge assembly rotatably securing the first and second portions. The two axis hinge assembly can include a directional locking mechanism on a first axis of rotation such that when operated in one rotational direction the first axis has less resistance to rotation than a second axis. When operated in an opposite rotational direction the first axis has more resistance to rotation than the second axis.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced.

FIG. 1 is an example computing device that includes a progressive hinge example in accordance with some implementations of the present concepts.

FIGS. 2A-2B and 3 are elevational views of a progressive hinge example in accordance with some implementations of the present concepts.

FIG. 4 offers perspective views of another progressive hinge example in accordance with some implementations of the present concepts.

### DESCRIPTION

The present concepts relate to computing devices that incorporate hinge assemblies. Progressive hinge assemblies can allow the computing devices to be easily opened by a user, but once open, the progressive hinge assemblies can provide ample resistance to support the computing device in a desired orientation.

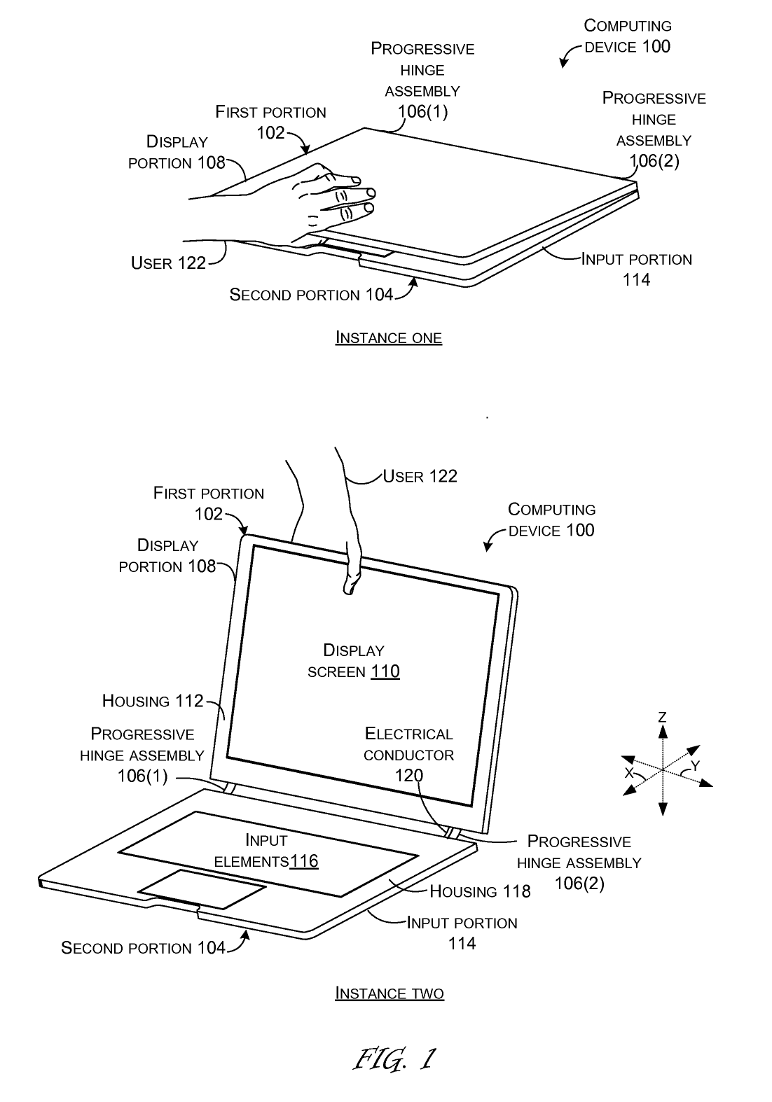

Introductory FIG. 1 shows an example of a computing device 100 that has first and second portions 102 and 104 that are rotatably secured together by progressive hinge assemblies 106. One or more progressive hinge assemblies can be employed to secure the first and second portions. In this example two progressive hinge assemblies 106(1) and 106(2) are utilized. In this case, the computing device's first portion is manifest as a display portion 108. The display portion 108 can include a display screen 110 positioned in a housing 112. The second portion 104 can be manifest as an input portion 114 that includes input elements 116, such as a keyboard, mouse, trackpad, etc. in a housing 118. The progressive hinge assemblies 106(1) and 106(2) can safely allow electrical conductors 120, to pass between the two portions and electrically interconnect electronic components thereof, such as the display screen 110 and input elements 116, among others.

The progressive hinge assembly 106 can rotatably secure the first portion 102 and the second portion 104 in a range of orientations and provide progressive resistance to further changes to the relative orientation. For example, Instance One shows the computing device in a storage position with the first and second portions positioned generally against or parallel to one another (in Instance One, the computing device is slightly opened). In this orientation, the user 122 can start to rotate the two portions away from each other with very little rotational force (e.g., torque). For example, in some implementations, the progressive hinge assembly 106 can allow the user to separate the two portions simply by lifting up with one hand on the first portion 102 without holding down the second portion 104. However, the resistance offered by the progressive hinge assembly increases at other relative orientations. For example, as shown at Instance Two, the progressive hinge assemblies can offer sufficient resistance to maintain the two portions in a usage or deployed orientation (e.g., commonly 90-130 degrees, for example).

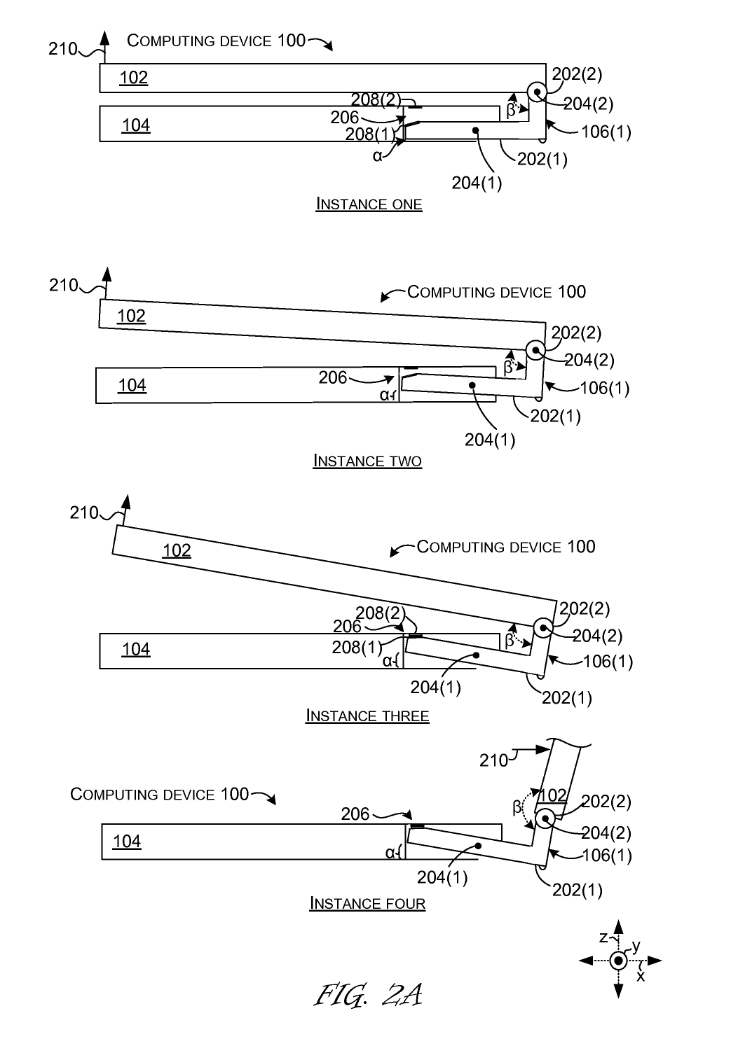

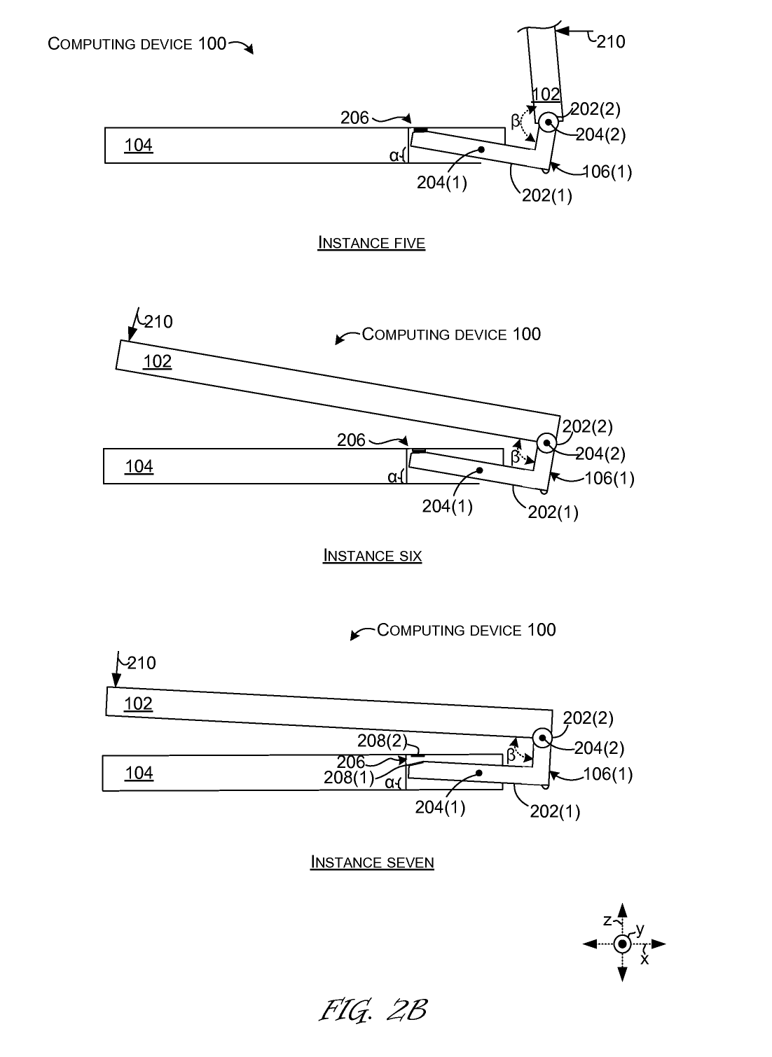

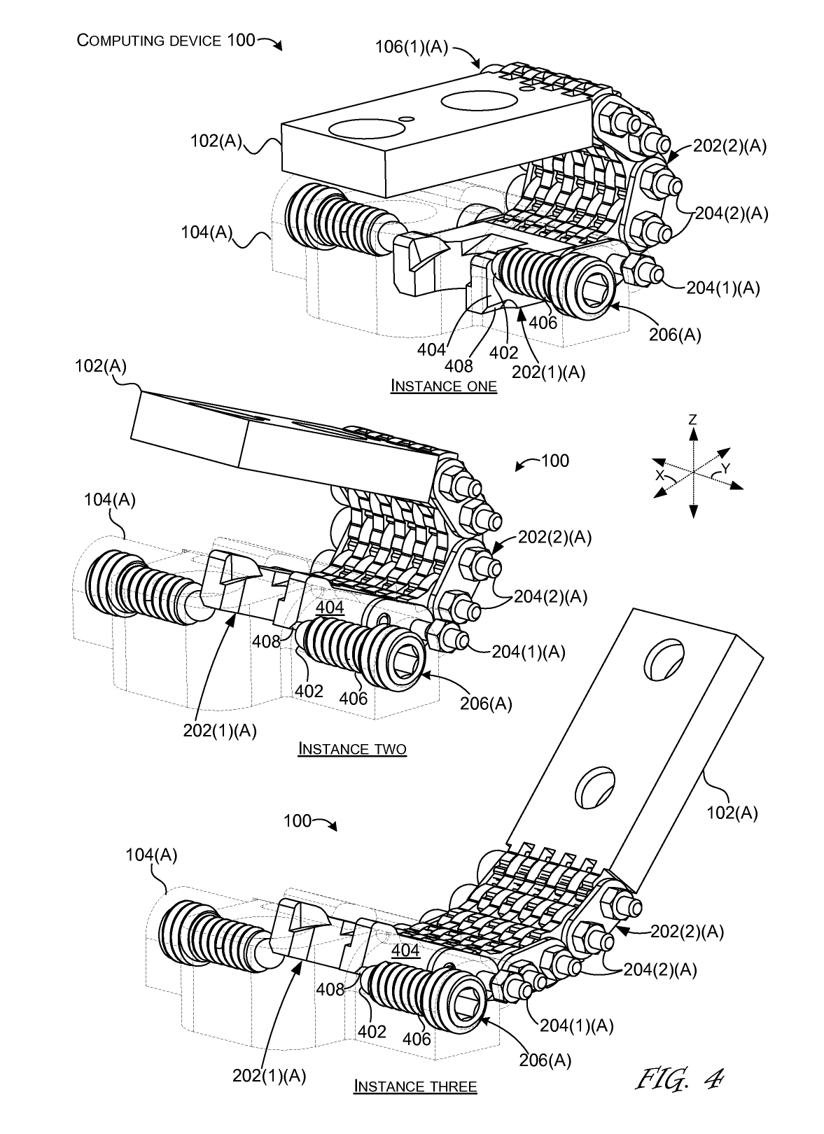

FIGS. 2A-2B collectively show further detail regarding one implementation of progressive hinge assembly 106(1). In this example, progressive hinge assembly 106(1) can include a first hinge sub-assembly 202(1) and a second hinge sub-assembly 202(2). In this implementation, first hinge sub-assembly 202(1) can rotate around axis 204(1) and second hinge sub-assembly 202(2) can rotate around axis 204(2). The first hinge sub-assembly 202(1) can include a locking or biasing mechanism 206. In this case, the locking mechanism is manifest as a first magnet 208(1) on the first hinge sub-assembly 202(1) and a second magnet 208(2) on the second portion 104. (Note that one of the magnets could be replaced with a ferromagnetic material that is attracted to magnets but is not itself magnetic.) Other examples of locking mechanisms are described below, such as relative to FIG. 4.

Instance One of FIG. 2A shows a storage orientation where the first and second portions 102 and 104 are positioned generally parallel to one another. Starting at Instance One, a force can be applied to separate the first and second portions. In this case, the force is represented by up arrow 210 on first portion 102. The first hinge sub-assembly 202(1) is configured to offer less resistance to rotation than the second hinge sub-assembly to a force or torque applied between the first and second portions. As evidenced in Instance Two, first hinge sub-assembly 202(1) is pivoting around axis 204(1). In contrast, second hinge sub-assembly 202(2) has not rotated around axis 204(2) and remains in the same relative configuration as Instance One.

At Instance Three the force 210 continues and first hinge sub-assembly 202(1) completes its range of rotation α. In this case, the range of rotation of the first hinge sub-assembly can be from about 10 degrees to about 40 degrees. At this point the locking mechanism 206 engages. In this case, the first and second magnets 208(1) and 208(2) attract each other and contact one another. The locking mechanism can provide a resilient bias of first hinge sub-assembly 202(1) to movement in the opposite direction. This aspect will re-enter the discussion at Instance Five. Looking again at Instance Three, at this point the second hinge sub-assembly 202(2) has not rotated and remains in the same relative configuration as Instance One and Instance Two. At this instance further rotation is limited to second hinge sub-assembly 202(2) since the first hinge assembly 202(1) is blocked from further rotation by the housing of the second portion 104.

If the force 210 is sufficient then additional rotation can occur in the second hinge sub-assembly 202(2) as evidenced at Instance Four (e.g., the change in angle β). Note that in this implementation as the first and second portions 102 and 104 are rotated apart, the first hinge sub-assembly 202(1) completes the first range of rotation α before the second hinge sub-assembly 202(2) starts the second range of rotation β. For example, the first range of rotation of the first hinge sub-assembly could be about 20 degrees of rotation. The second range of motion of the second hinge sub-assembly could be from 20 degrees to about 110 degrees as visualized in the deployed orientation of Instance Four. Of course, these are examples provided for purposes of explanation and other range values are contemplated. For instance, the second range can extend to 180 degrees or more.

Instance Four shows an example of a usage or deployed orientation. At this point, the progressive hinge 106(1) can offer sufficient resistance to further rotation to maintain the computing device 100 in this orientation (e.g., the first portion 102 does not fall down under its own weight).

Instance Five shows the user pushing the first and second portions 102 and 104 back towards one another as evidenced by arrow 210. In this configuration of the progressive hinge assembly, the locking mechanism 206 provides relatively high resistance to rotation for the first hinge sub-assembly 202(1). As a result, the second hinge sub-assembly 202(2) starts to rotate first (as evidenced at angle β) while the first hinge sub-assembly 202(1) does not rotate (e.g., maintains its angle α).

Instance Six shows the second hinge sub-assembly 202(2) nearing its minimum angle as the completion of its rotation evidenced by angle β. At this point, the first hinge sub-assembly 202(1) has not started its rotation. In this configuration, additional force is required to overcome the bias offered by the locking mechanism 206 before rotation of the first hinge sub-assembly 202(1) will start.

Instance Seven shows that the user has continued to force the first portion 102 downward (e.g. toward the second portion 104) as indicated by arrow 210 sufficiently to overcome the locking mechanism 206. The first hinge sub-assembly 202(1) is now rotating as evidenced by decreasing angle α. Continued downward movement of the first portion will return the first portion 102 and the second portion 104 to the relative orientation shown in Instance One.

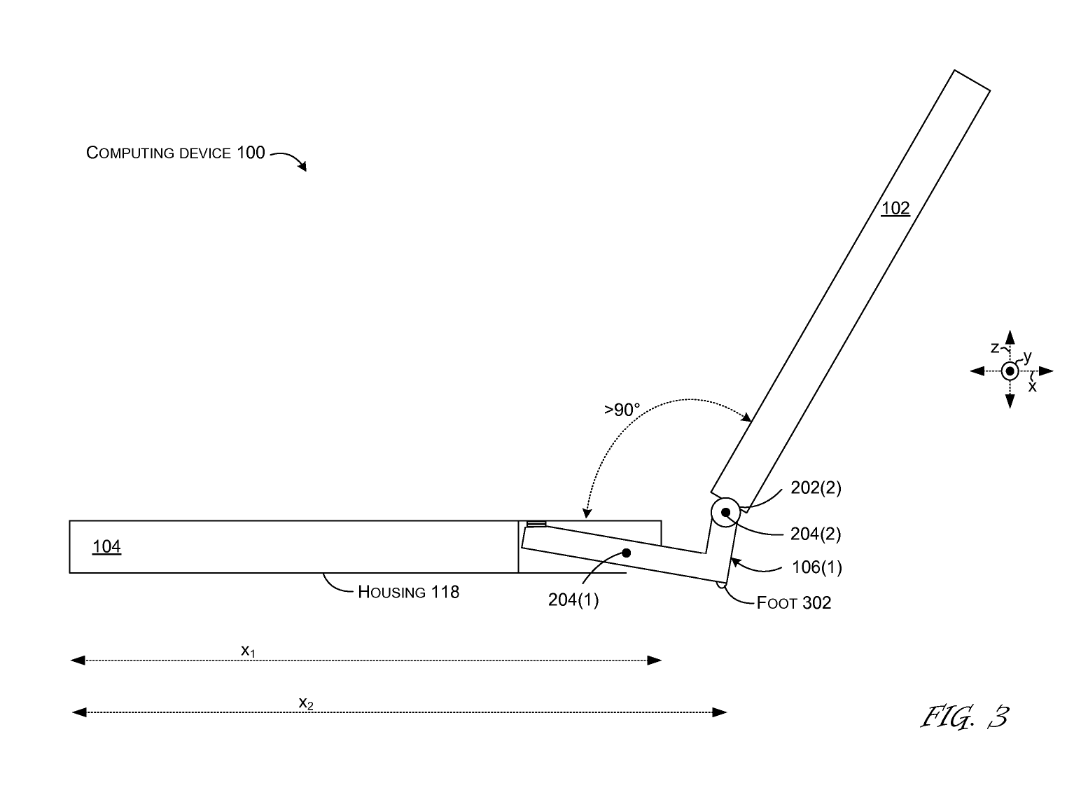

FIG. 3 illustrates a further advantage offered by progressive hinge assembly 106(1) to computing device 100. Note that housing 118 can create a footprint or contact length in the x direction (e.g., front to back) defined by dimension x₁. When deployed to usage orientations, the progressive hinge assembly 106(1) can extend this contact length to dimension x₂. The greater dimension of x₂ can increase the stability of the computing device. Stated another way, the progressive hinge assembly 106(1) can decrease a likelihood of the computing device tipping back when the user tilts the first portion 102 at angles greater than 90 degrees relative to the second portion 104. This can be especially advantageous in computing device configuration where many of the electronic components, which tend to be relatively heavy, such as the processor and memory are positioned in the first portion and relatively lightweight components, such as input devices are positioned in the second portion. Toward this end, this implementation of the progressive hinge assembly 106(1) can be thought of as providing a foot 302 that can extend the contact length and increase stability.

FIG. 4 shows further detail regarding another implementation of a progressive hinge assembly 106(1)(A) as can be employed with computing device 100. The progressive hinge assembly is rotatably securing first portion 102(A) and second portion 102(B). Portion 102(B) is shown in ghost (e.g., dotted lines) to aid in visualization of the underlying structures.

In this example, progressive hinge assembly 106(1)(A) can include a first hinge sub-assembly 202(1)(A) and a second hinge sub-assembly 202(2)(A). In this implementation, first hinge sub-assembly 202(1)(A) can rotate around axis 204(1)(A) and second hinge sub-assembly 202(2)(A) can rotate around axis 204(2)(A). (In this case the second hinge sub-assembly can be thought of as a radius hinge that rotates around multiple axes but the progressive hinge concepts do not rely on the number of axes of the second hinge sub-assembly. For example, relative to FIG. 2A-2B, the second hinge sub-assembly is manifest as a friction hinge that rotates around a single axis. The use of other hinge types is contemplated).

The first hinge sub-assembly 202(1)(A) can include a biasing or locking mechanism 206(A). In this case, the locking mechanism is manifest as a pair of cooperatively operating locking mechanisms, only one of which is specifically designated. The locking mechanisms can include a ball bearing 402 that is resiliently biased toward a surface 404 of the first hinge sub-assembly 202(1)(A) by a spring 406. The first hinge sub-assembly can include a detent 408 relative to surface 404.

Instance One of FIG. 4 shows the progressive hinge assembly 106(1)(A) in the storage position where the first and second portions 102(A) and 104(A) are relatively parallel to one another. Note that in some implementations, the second hinge sub-assembly 202(2)(A) can include rotation limiters so that the first portion 102(A) cannot rotate any farther relative to the second portion 104(A).

At this point an upward force on the first portion 102(A) can cause rotation of the first hinge sub-assembly 202(1)(A) around axis 204(1)(A). This rotation can cause ball bearing 402 to slide across surface 404. Stated another way, the resistance to rotation beginning at Instance One can be less for the first hinge sub-assembly 202(1)(A) than the second hinge sub-assembly 202(2)(A) and as such rotation begins in the first hinge sub-assembly and not the second hinge sub-assembly 202(2)(A).

At Instance Two, ball bearing 402 is pushed into detent 408 by spring 406 and further rotation of the first hinge sub-assembly 202(1)(A) is blocked by the second portion 104(A). At this point the resistance to further rotation offered by the first hinge sub-assembly 202(1)(A) is greater than the second hinge sub-assembly 202(2)(A). Thus, continued rotation of the first portion 102(A) relative to the second portion 104(A) (e.g., opening) can be accomplished via rotation within the second hinge sub-assembly 202(2)(A). Also, ball bearing 402 being pushed into detent 408 can serve to ‘lock out’ or limit rotation of first hinge sub-assembly 202(1)(A) back toward the orientation of Instance One. Thus, the biased ball bearing and the detent can be thought of as another example of locking mechanism 206 introduced above relative to FIG. 2A. Other implementations could replace the ball bearing with a rod shaped element, among other configurations.

Instance Three shows first hinge sub-assembly 202(1)(A) in the same position as Instance Two, but relative rotation of the first and second portions 102(A) and 104(A) has continued via second hinge sub-assembly 202(2)(A). At this point, the first hinge sub-assembly 202(1)(A) is locked out from rotation, and the resistance of the second hinge sub-assembly 202(2)(A) can support the first portion 102(A) in a desired orientation (e.g., the first and second portions do not rotate from their own weight and maintain the relative orientation of Instance Three unless the user imparts a force on either or both of the first and second portions). If the user decides to close the computing device (e.g., the progressive hinge assembly 106(1)(A)) the user can impart a force to push the first and second portions toward one another. At this point, the second hinge sub-assembly 202(2)(A) offers less resistance to rotation and if the force is sufficient, the second hinge sub-assembly will rotate back to the orientation shown in Instance Two. At that point, the second hinge sub-assembly 202(2)(A) is stopped from further rotation. At that instance, if the force is sufficient, the ball bearing 402 will be forced out of the detent 408 and rotation can commence in the first hinge sub-assembly 202(1)(A). Stated another way, when locked out, the first hinge sub-assembly 202(1)(A) has a high resistance to rotation. Once that resistance to rotation is overcome, the first hinge sub-assembly offers a relatively low resistance to rotation (even lower than the resistance to rotation of the second hinge sub-assembly 202(2)(A)).

Beginning at the storage position and with the user starting to open the computing device, the first hinge sub-assembly 202(1)(A) offers relatively lower resistance than the second hinge sub-assembly 202(2)(A) until the first hinge sub-assembly locks out. At that point, resistance of the second hinge sub-assembly 202(2)(A) can be sufficient to hold the first portion 102(A) in an orientation selected by the user. As the user starts closing the computing device the second hinge sub-assembly 202(2)(A) provides less resistance to rotation until it completes its rotation. At this point the user can exert extra force to overcome the resistance of the ball bearing and detent of the first hinge sub-assembly 202(1)(A) after which the first hinge sub-assembly provides low resistance to further rotation.

In this configuration, the lock-out feature of the first hinge sub-assembly 202(1)(A) can be readily apparent to the user via tactile feedback. As such, the lock out feature can be utilized as a control mechanism for various functionalities offered by the computing device. For instance, the lock-out position can be tied to the state of the computing device. For example, if the user opens the computing device past the lock-out position, the computer can be awakened or powered-up. Similarly, if the user is using the computing device and wants to carry the computing device while keeping the computing device powered up, the user can close the first portion until they feel the lock out and then stop. If they want the computing device to power down (e.g., change power states) the user can push more to overcome the lock out which can cause the power state to change.

Examples of specific structures are described above. These structures can implement one example of a progressive hinge concept. More specifically, this hinge concept can relate to how a computing device opens and closes. When starting with the computing device at the closed or storage orientation and opening the computing device, rotation can occur around a first axis and then continue around a second different axis. Upon closing, the rotation can begin around the second axis and then finish around the first axis toward the storage orientation. Another aspect can provide an easy to open computing device from the storage orientation and after a number of degrees of rotation, the resistance to further rotation increases (e.g., the resistance to rotation can progressively increase as the computing device is opened from the storage orientation).

Individual elements of the progressive hinge assemblies can be made from various materials, such as sheet metals, die cast metals, machined metals, and/or molded plastics, among others, or any combination of these and/or other materials. The progressive hinge assemblies can be utilized with various types of computing devices, such as notebook computers, foldable tablet type computers, smart phones, wearable smart devices, gaming devices, entertainment consoles, and/or other developing or yet to be developed types of computing devices. As used herein, a computing device can be any type of device that has some amount of processing and/or storage capacity.

### FURTHER EXAMPLES

The above discussion relates to devices, such as computing devices that have hinged portions. One example can include a first portion and a second portion. The example can also include a progressive hinge assembly rotatably securing the first portion and the second portion in a range of orientations from a storage orientation to a deployed orientation. The hinge assembly can include at least first and second hinge sub-assemblies. The first hinge sub-assembly can provide a first range of rotation and the second hinge sub-assembly can provide a second range of rotation. In an instance where the first portion and the second portion are positioned parallel to one another in the storage orientation the first hinge sub-assembly can offer less resistance to rotation than the second hinge sub-assembly.

The computing device of the above and/or below examples, where the first portion includes a first housing and the second portion includes a second housing. The first hinge sub-assembly is secured to the first housing and the second hinge sub-assembly. The second hinge sub-assembly is secured to the second housing.

The computing device of the above and/or below examples, where the first hinge sub-assembly extends a contact length of the computing device upon completion of the first range of rotation compared to a contact length of the first housing.

The computing device of the above and/or below examples, where the first hinge sub-assembly functions as a foot. The foot extends a contact length of the computing device upon completion of the first range of rotation compared to a contact length of the first housing.

The computing device of the above and/or below examples, where the first portion includes an input portion. The input portion includes a keyboard and the second portion includes a display portion that includes a display screen.

The computing device of the above and/or below examples, where the first range of rotation is manifest as zero to 20 degrees and the second range of rotation comprises 20 to 180 degrees.

The computing device of the above and/or below examples, where the first hinge sub-assembly includes a locking mechanism that engages when the first range of rotation is completed.

The computing device of the above and/or below examples, where the locking mechanism offers a greater resistance to rotation than the second hinge sub-assembly.

The computing device of the above and/or below examples, where the first hinge sub-assembly is positioned in a housing of the first portion and the locking mechanism is manifest as a magnet on the first hinge sub-assembly and another magnet on a housing of the first portion.

The computing device of the above and/or below examples, where the first hinge sub-assembly is positioned in a housing of the second portion. The locking mechanism is manifest as a magnet on the first hinge sub-assembly and a ferromagnetic material on a housing of the second portion.

The computing device of the above and/or below examples, where the locking mechanism is manifest as a resiliently biased object that is biased into a detent.

The computing device of the above and/or below examples, where the resiliently biased object is manifest as a ball bearing or where the resiliently biased object is manifest as a rod shaped object that is resiliently biased with a spring.

The computing device of the above and/or below examples, when the first portion and the second portion are rotated apart, the first hinge sub-assembly completes the first range of rotation before the second hinge sub-assembly starts the second range of rotation, and where once the first and second portions are rotated past the first range, the first hinge sub-assembly offers more resistance to rotation than the second hinge sub-assembly when the first and second portions are rotated back towards one another

Another example computing device can include a first portion that includes a first electronic component and is electrically connected by electrical conductors to a second portion that includes a second electronic component. The example can also include a two axis hinge assembly rotatably securing the first and second portions. The two axis hinge assembly can include a locking mechanism on a first axis of rotation such that when operated in one rotational direction the first axis has less resistance to rotation than a second axis and when operated in an opposite rotational direction the first axis has more resistance to rotation than the second axis.

The computing device of the above and/or below examples, where the first axis is associated with a locking mechanism that is configured to engage when the first axis completes a range of rotation.

The computing device of the above and/or below examples, where the locking mechanism is configured to have a resistance to rotation in the opposite rotational direction that is greater than the resistance to rotation of the second axis.

The computing device of the above and/or below examples, where after the locking mechanism is disengaged, the first axis is configured to have a resistance to rotation in the opposite rotational direction that is less than the resistance to rotation of the second axis.

A further example computing device including a display portion that includes a display screen and an input portion that includes an input device. This example further including a progressive hinge assembly rotatably securing the display portion and the input portion and configured to allow the input portion and the display portion to be oriented generally parallel to one another in a storage orientation and rotated relative to one another into multiple orientations. Starting at the storage orientation and rotating the input portion and the display portion away from one another, the progressive hinge assembly is configured to offer a relatively low resistance to rotation through a first range of rotation and then a relatively high resistance to rotation through a second range of rotation.

The computing device of the above and/or below examples, where the progressive hinge assembly is manifest as a first hinge sub-assembly configured to rotate through the first range of rotation and a second hinge sub-assembly configured to rotate through the second range of rotation and then when the input portion and the display portion are rotated toward one another, the second hinge sub-assembly is configured to rotate back through the second range of rotation before the first hinge sub-assembly rotates back through the first range of rotation.

The computing device of the above and/or below examples, when a direction of rotation is reversed, the progressive hinge assembly is configured to provide the relatively high resistance to rotation through the second range of rotation, followed by a very high resistance of rotation between the second range and the first range followed by the relatively low resistance to rotation through the first range.

Another example computing device that includes first and second portions rotatably connected by a hinge assembly that includes first and second hinge sub-assemblies. The first hinge sub-assembly has a relatively low lower operational torque requirement for rotation through a first range of rotation and then has a relatively higher operational torque requirement. The second hinge sub-assembly has an operational torque requirement through a second range of rotation that is between the relatively lower operational torque requirement and the relatively higher operational torque requirement.

### EXAMPLE METHODS

Various methods of manufacture, assembly, and use for progressive hinge assemblies are contemplated beyond those shown above relative to FIGS. 1-4.

### Conclusion

Although techniques, methods, devices, systems, etc., pertaining to computing devices utilizing progressive hinge assemblies are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A computing device, comprising:
a first portion and a second portion; and,
a progressive hinge assembly rotatably securing the first portion and the second portion in a range of orientations from a storage orientation to a deployed orientation, the hinge assembly including:
at least first and second hinge sub-assemblies, wherein the first hinge sub-assembly provides a first range of rotation and the second hinge sub-assembly provides a second range of rotation, wherein in an instance where the first portion and the second portion are positioned parallel to one another in the storage orientation the first hinge sub-assembly offers less resistance to rotation than the second hinge sub-assembly.

2. The computing device of claim 1, wherein the first portion comprises a first housing and wherein the second portion comprises a second housing and wherein the first hinge sub-assembly is secured to the first housing and the second hinge sub-assembly, and the second hinge sub-assembly is secured to the second housing.

3. The computing device of claim 1, wherein the first hinge sub-assembly extends a contact length of the computing device upon completion of the first range of rotation compared to a contact length of the first housing.

4. The computing device of claim 1, wherein the first hinge sub-assembly functions as a foot and wherein the foot extends a contact length of the computing device upon completion of the first range of rotation compared to a contact length of the first housing.

5. The computing device of claim 1, wherein the first portion comprises an input portion that includes a keyboard and the second portion comprises a display portion that includes a display screen.

6. The computing device of claim 1, wherein the first range of rotation comprises zero to 20 degrees and the second range of rotation comprises 20 to 180 degrees.

7. The computing device of claim 1, wherein the first hinge sub-assembly includes a locking mechanism that engages when the first range of rotation is completed.

8. The computing device of claim 7, wherein the locking mechanism offers a greater resistance to rotation than the second hinge sub-assembly.

9. The computing device of claim 7, wherein first hinge sub-assembly is positioned in a housing of the first portion and the locking mechanism comprises a magnet on the first hinge sub-assembly and another magnet on a housing of the first portion.

10. The computing device of claim 7, wherein first hinge sub-assembly is positioned in a housing of the second portion and the locking mechanism comprises a magnet on the first hinge sub-assembly and a ferromagnetic material on a housing of the second portion.

11. The computing device of claim 7, wherein the locking mechanism comprises a resiliently biased object that is biased into a detent.

12. The computing device of claim 11, wherein the resiliently biased object comprises a ball bearing or wherein the resiliently biased object comprises a rod shaped object that is resiliently biased with a spring.

13. The computing device of claim 1, wherein when the first portion and the second portion are rotated apart, the first hinge sub-assembly completes the first range of rotation before the second hinge sub-assembly starts the second range of rotation, and wherein once the first and second portions are rotated past the first range, the first hinge sub-assembly offers more resistance to rotation than the second hinge sub-assembly when the first and second portions are rotated back towards one another.

14. A computing device, comprising:
a first portion that includes a first electronic component and is electrically connected by electrical conductors to a second portion that includes a second electronic component; and,
a two axis hinge assembly rotatably securing the first and second portions, the two axis hinge assembly including a locking mechanism on a first axis of rotation such that when operated in one rotational direction the first axis has less resistance to rotation than a second axis and when operated in an opposite rotational direction the first axis has more resistance to rotation than the second axis.

15. The computing device of claim 14, wherein the first axis is associated with a locking mechanism that is configured to engage when the first axis completes a range of rotation.

16. The computing device of claim 15, wherein the locking mechanism is configured to have a resistance to rotation in the opposite rotational direction that is greater than the resistance to rotation of the second axis.

17. The computing device of claim 16, wherein after the locking mechanism is disengaged, the first axis is configured to have a resistance to rotation in the opposite rotational direction that is less than the resistance to rotation of the second axis.

18. A computing device, comprising:
a display portion that includes a display screen and an input portion that includes an input device; and,
a progressive hinge assembly rotatably securing the display portion and the input portion and configured to allow the input portion and the display portion to be oriented generally parallel to one another in a storage orientation and rotated relative to one another into multiple orientations, and wherein starting at the storage orientation and rotating the input portion and the display portion away from one another, the progressive hinge assembly is configured to offer a relatively low resistance to rotation through a first range of rotation and then a relatively high resistance to rotation through a second range of rotation.

19. The computing device of claim 18, wherein the progressive hinge assembly comprises a first hinge sub-assembly configured to rotate through the first range of rotation and a second hinge sub-assembly configured to rotate through the second range of rotation and then when the input portion and the display portion are rotated toward one another, the second hinge sub-assembly is configured to rotate back through the second range of rotation before the first hinge sub-assembly rotates back through the first range of rotation.

20. The computing device of claim 18, wherein when a direction of rotation is reversed, the progressive hinge assembly is configured to provide the relatively high resistance to rotation through the second range of rotation, followed by a very high resistance of rotation between the second range and the first range followed by the relatively low resistance to rotation through the first range.
